(19) United States
(12) Patent Application Publication
(10) Pub. No.: US 2024/0020573 A1
(43) Pub. Date: Jan. 18, 2024

(54) Extending Forecasting Models for Forecast/Evaluation Granularity Mismatch

(71) Applicant: Google LLC, Mountain View, CA (US)

(72) Inventors: Wangyang Zhang, Allison Park, PA (US); Leyou Zhang, Metuchen, NJ (US); Rajarishi Sinha, Pittsburgh, PA (US); Michael Peter Perrone, Yorktown Heights, NY (US); Andrew James McGehee, Auburn, AL (US); Dawei Jia, Sunnyvale, CA (US); Jingtao Wang, Pittsburgh, PA (US)

(21) Appl. No.: 17/862,765

(22) Filed: Jul. 12, 2022

(51) Int. Cl. G06N 20/00; G06Q 10/04

(52) U.S. Cl. CPC G06N 20/00; G06Q 10/04

(57) ABSTRACT

Aspects of the disclosure are directed to an approach for extending forecasting models to various levels of granularity. The approach can include receiving a target level of granularity for distributing a forecast, performing forecast modeling at an aggregated level of granularity, and determining a distribution method to distribute results of the forecast model at the target level of granularity. The approach can improve performance over existing forecasting models with minimal overhead.

### BACKGROUND

Forecasting involves making predictions based on past and present data and can be performed at different levels of granularity. However, accuracy can become an issue when forecasting at finer levels of granularity. This can be due to sparse data, such as prediction targets being mostly 0. For example, predicting retail sale of a store by the day can be difficult because it is common for more than 90% of products to have 0 sales most of the days at the store. Similarly, predicting future transactions of an account by the days can be difficult because the account is likely to have 0 transactions on most days. As another example, predicting a number of users for a mobile application in a small geographic area or during a short period of time can be difficult because the application could have 0 usage depending on the size of the geographic area or length of time. Further, precise timing for non-zero forecasts can be highly unpredictable, as it often relies on a single person making a spontaneous decision, such as going to a store or using a mobile application. Because of the accuracy issues, forecasting tends to occur at coarser levels of granularity than desired, or accuracy is deemphasized at the finer levels of granularity.

### BRIEF SUMMARY

Aspects of the disclosure are directed to an approach for extending forecasting models to various levels of granularity. For example, forecasting models can be extended to finer levels of granularity where accuracy is difficult to achieve because of sparse data. The approach can include receiving a target level of granularity for distributing a forecast, performing forecast modeling at an aggregated level of granularity, and determining a distribution method to distribute results of the forecast model at the target level of granularity. The approach can improve performance over existing forecasting models with minimal overhead.

An aspect of the disclosure provides for a method for forecasting independent of level of granularity. The method includes receiving, with one or more processors, a target evaluation metric for performing a forecast, the target evaluation metric including a target level of granularity; performing, with the one or more processors, the forecast at an aggregated level of granularity compared to the target level of granularity to generate an aggregated forecast result; determining, with the one or more processors, a distribution scheme for distributing the aggregated forecast result to the target level of granularity; and distributing, with the one or more processors, the aggregated forecast result to the target level of granularity based on the determined distribution method to generate a forecast result at the target level of granularity.

In an example, the data for the forecasting at the target level of granularity is sparse. In another example, the target evaluation metric includes a target quality for the forecasting model. In yet another example, the target level of granularity includes a level of a category, location, or time. In yet another example, the target evaluation metric further includes a weight, where the target level of granularity is based on the weight.

In yet another example, the method further includes aggregating, with the one or more processors, the target level of granularity via an aggregation scheme. In yet another example, the aggregation scheme includes one of a sum or average for numerical features of data for the forecasting. In yet another example, the aggregation scheme includes one of a most frequent value or a concatenate of unique values for categorical features of data for the forecast. In yet another example, the method further includes performing, with the one or more processors, training for the forecast at the aggregated level of granularity.

In yet another example, determining the distribution method further includes comparing an accuracy of combinations of evaluation metrics at the target level of granularity using a validation dataset. In yet another example, determining the distribution method further includes generating heuristics to narrow the combination of evaluation metrics to compare.

Another aspect of the disclosure provides for a system including one or more processors; and one or more storage devices coupled to the one or more processors and storing instructions that, when executed by the one or more processors, causes the one or more processors to perform operations for forecasting independent of level of granularity. The operations include receiving a target evaluation metric for performing a forecast, the target evaluation metric including a target level of granularity; performing the forecast at an aggregated level of granularity compared to the target level of granularity to generate an aggregated forecast result; determining a distribution scheme for distributing the aggregated forecast result to the target level of granularity; and distributing the aggregated forecast result to the target level of granularity based on the determined distribution method to generate a forecast result at the target level of granularity.

In an example, the target level of granularity includes a level of a category, location, or time. In another example, the operations further include aggregating the target level of granularity via an aggregation scheme, the aggregation scheme including one of a sum or average for numerical features of data for the forecasting or a most frequent value or a concatenate of unique values for categorical features of data for the forecast. In yet another example, determining the distribution method further includes comparing an accuracy of combinations of evaluation metrics at the target level of granularity using a validation dataset. In yet another example, determining the distribution method further includes generating heuristics to narrow the combination of evaluation metrics to compare.

Yet another aspect of the disclosure provides for a non-transitory computer readable medium for storing instructions that, when executed by one or more processors, causes the one or more processors to perform operations for forecasting independent of level of granularity. The operations include receiving a target evaluation metric for performing a forecast, the target evaluation metric including a target level of granularity; performing the forecast at an aggregated level of granularity compared to the target level of granularity to generate an aggregated forecast result; determining a distribution scheme for distributing the aggregated forecast result to the target level of granularity; and distributing the aggregated forecast result to the target level of granularity based on the determined distribution method to generate a forecast result at the target level of granularity.

In an example, the operations further include aggregating the target level of granularity via an aggregation scheme, the aggregation scheme including one of a sum or average for numerical features of data for the forecasting or a most frequent value or a concatenate of unique values for categorical features of data for the forecast. In another example, determining the distribution method further includes comparing an accuracy of combinations of evaluation metrics at the target level of granularity using a validation dataset. In yet another example, determining the distribution method further comprises generating heuristics to narrow the combination of evaluation metrics to compare.

### BRIEF DESCRIPTION OF THE DRAWINGS

FIG. 1 depicts a block diagram of an example forecast system that allows for extending forecasting models to various levels of granularity according to aspects of the disclosure.

FIG. 2 depicts a block diagram illustrating one or more forecast model architectures for providing forecasting results according to aspects of the disclosure.

FIG. 3 depicts a flow diagram of an example process for distributing forecast results at various levels of granularity according to aspects of the disclosure.

FIG. 4 depicts a block diagram of an example environment for implementing the forecast system according to aspects of the disclosure.

### DETAILED DESCRIPTION

Generally disclosed herein are implementations for extending forecasting models to various levels of granularity, such as finer levels of granularity where accuracy is difficult to achieve. The implementations include receiving a target level of granularity for distributing a forecast, performing forecast modeling at an aggregated level of granularity compared to the target level of granularity, and determining a distribution scheme to distribute results of the forecast model at the target level of granularity. The approach can improve performance over existing forecasting models with minimal overhead.

For each target evaluation metric, a name of the metric and a granularity level of the metric can be received. Evaluation metrics can measure quality, e.g., error, of statistical or machine learning models. Example evaluation metrics can include mean absolute error (MAE) and root mean squared error (RMSE). The granularity level of the metric can be the specificity of the evaluation for a feature. Example granularities can include levels of category, location, and time.

Receiving a target evaluation metric can also include receiving a weight for each metric if multiple evaluation metrics are received. If multiple received evaluation metrics are not at the same level of granularity, modeling can be performed at the granularity of the evaluation metric with the highest weight. Modeling can also be performed at the granularity of the evaluation metric with the highest accuracy based on testing performed with a validation dataset. A weight can also be received for granularity levels of a metric. The weight can determine which granularity levels have a more important accuracy for a particular forecast model.

Performing forecast modeling at an aggregated or coarser level of granularity compared to the received target level of granularity can include aggregating the level of granularity. The aggregated level of granularity can be predetermined depending on the particular forecast model to be performed. For example, the aggregated level of granularity can be predetermined based on the level of granularity with the highest weight.

Aggregating the level of granularity can include summing or averaging values that satisfy a condition for the forecast when features of the forecast are numerical. Aggregating the level of granularity can also include a most frequent value or a concatenate of unique values that satisfy a condition for the forecast when features of the forecast are categorical. The aggregation scheme, e.g., summing, averaging, most frequent, or concatenate, can be predetermined based on a type of feature, such as a numerical or categorical feature. For example, the predetermined aggregation scheme for numerical features can be summation while the predetermined aggregation scheme for categorical features can be a most frequent value. The aggregation scheme can also be selected or the predetermined scheme changed based on a particular feature, such as inventory, returns, replenishment, or price for a sales prediction target.

The forecast model can be generated based on the aggregated data derived from the aggregation scheme. The generated forecast model can output results of a forecast at the aggregated level of granularity.

The generated forecast model can also be trained at the aggregated or coarser level of granularity. Training the forecast model at the aggregated level of granularity can include performing training at multiple levels of a granularity hierarchy, where the output at any level of granularity is a combination of values at different levels of the granularity hierarchy. For example, one forecast model can be trained at the highest level of granularity and another forecast model can be trained at the lowest level of granularity. As another example, a forecast model can be trained at each level of granularity. As yet another example, forecast models can be trained at predetermined levels of granularity. As yet another example, forecast models of one feature can be trained at a level of granularity dependent on another feature. Multiple iterations of training can be performed, where the combination of the iterations of training can be one of a weighted sum based on granularity level, a non-linear combination based on granularity level, or a linear or non-linear combination with constraints, such as normalization. Regularization, such as ridge regression or lasso regression, can be applied during training at the multiple levels of the granularity hierarchy to mitigate for insufficient data leading to biased and/or overfit results.

Determining a distribution scheme for distributing results of the forecast model at the target level of granularity can include comparing accuracy of combinations of evaluation metrics at the target level of granularity using a validation dataset. Comparing the evaluation metrics can be represented as a hyperparameter tuning problem, where the number of hyperparameters can be the number of granularity layers between the aggregated level of granularity and the target level of granularity. The hyperparameter tuning problem can be solved by any hyperparameter tuning tool, such as black-box optimization. The hyperparameter tuning problem can also be solved by a grid search if the number of combinations is below a threshold. Determining the distribution scheme can also include generating heuristics to narrow the number of combinations of evaluation metrics to compare. For example, it may already be known that some granularity differences are significant and cannot be ignored while other granularity differences are not significant and can be ignored. The forecast results can be distributed at the target level of granularity based on the determined distribution scheme.

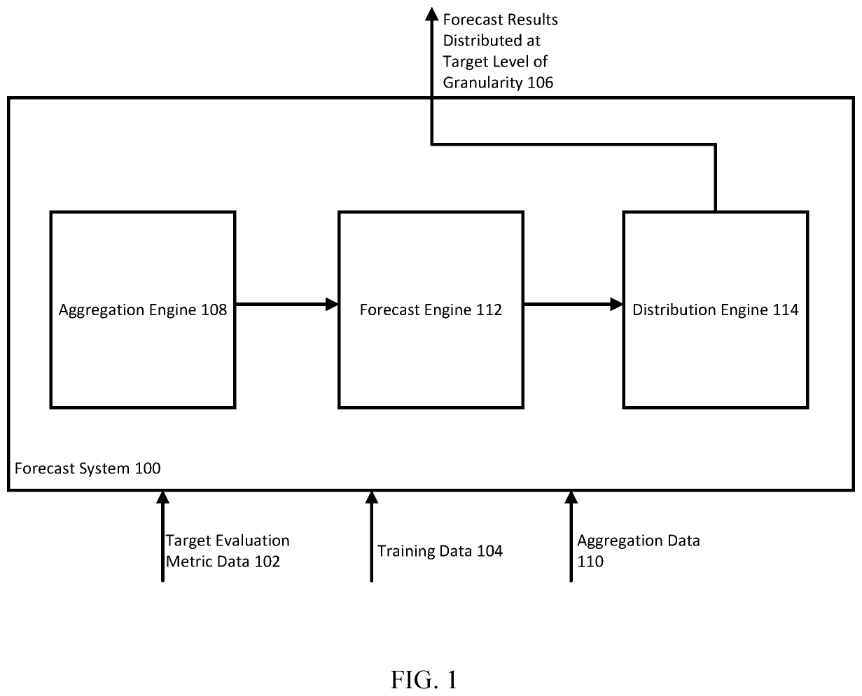

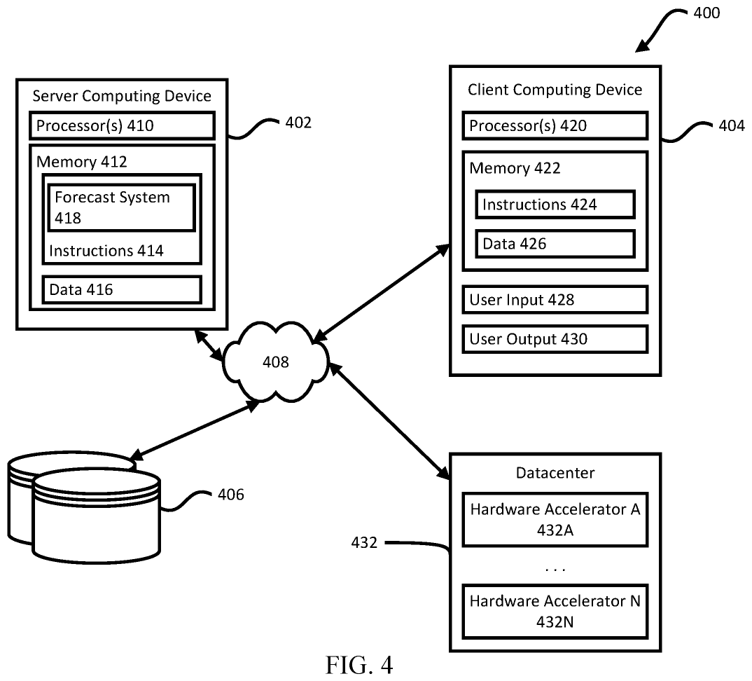

FIG. 1 depicts a block diagram of an example forecast system 100 that allows for extending forecasting models to various levels of granularity. The forecast system 100 can be configured to receive the input data according to a user interface. For example, the forecast system 100 can receive the data as part of a call to an Application Programming Interface (API) exposing the forecast system 100. The forecast system 100 can be implemented on one or more computing devices, such as the environment 400 of FIG. 4, to be described further below. Input to the forecast system 100 can be provided, for example, through a storage medium, including remote storage connected to the one or more computing devices over a network, or as input through a user interface on a client computing device coupled to the forecast system 100.

The forecast system 100 can be configured to receive target evaluation metric data 102 for forecasting and training data 104 for training forecast models. The forecast system 100 can be configured to implement the techniques for extending forecast model to various levels of granularity, to be described further below.

The target evaluation metric data 102 can correspond to measuring a quality of a forecast model at a target level of granularity. Various evaluation metrics can test the quality of the forecast model, such as mean absolute error and root mean squared error. Evaluation metrics can involve using a combination of these individual evaluation metrics to test a model. Mean absolute error can correspond to a measure of error between values predicted and values observed. Mean absolute error can be determined by a sum of absolute errors divided by a sample size, more generally an arithmetic average of absolute errors. Root mean squared error can also correspond to a measure of error between values predicted and values observed. Root mean squared error can be determined by quadratic mean of differences between predicted values and observed values. Root mean squared error can aggregate magnitudes of errors in predictions into a single measure of accuracy.

The target evaluation metric data 102 can include a granularity level for the metric. The granularity level of the metric can be the specificity of the evaluation for a feature. Example granularities can include levels of category, location, and time. Levels of category can include specificity of types of categorical features, levels of location can include a size of spatial features, and levels of time can include a length of temporal features.

The target evaluation metric data 102 can further include a weight for each metric if multiple evaluation metrics are received. If multiple received evaluation metrics are not at the same level of granularity, forecast modeling can be performed at the granularity of the evaluation metric with the highest weight. Forecast modeling can also be performed at the granularity of the evaluation metric with the highest predetermined accuracy based on testing performed with a validation dataset.

A weight can also be received for granularity levels of a metric. The weight can determine which granularity levels have a more important accuracy for a particular forecast model.

The training data 104 can correspond to training forecast models. The training data 104 can be in any form suitable for training the forecast models, according to one of a variety of different learning techniques. Learning techniques for training the forecast models can include supervised learning, unsupervised learning, and semi-supervised learning techniques. For example, the training data 104 can include multiple training examples that can be received as input by the forecast models. The training examples can be labeled with a desired output for the forecast models when processing the labeled training examples. The label and the model output can be evaluated by the evaluation metrics, which can be backpropagated through the forecast model to update weights for the forecast model.

The forecast system 100 can be configured to output forecast results 106 distributed at the target level of granularity from the target evaluation metric 102. The forecast results 106 can be sent as an output, for example displayed on a user display. The forecast system 100 can be configured to provide the forecast results 106 as a set of computer-readable instructions, such as one or more computer programs, which can be executed to further train, fine-tune, and/or deploy the forecast models. A computer program can be written in any type of programming language, and according to any programming paradigm, e.g., declarative, procedural, assembly, object-oriented, data-oriented, functional, or imperative. A computer program can be written to perform one or more different functions and to operate within a computing environment, e.g., on a physical device, virtual machine, or across multiple devices. A computer program can also implement functionality described in this specification, for example, as performed by a system, engine, module, or model.

The forecast system 100 can include an aggregation engine 108. The aggregation engine 108 can aggregate the level of granularity compared to the target level of granularity from the target evaluation metric 102. The aggregated level of granularity can be predetermined depending on the particular forecast model to be performed. For example, the aggregated level of granularity can be predetermined based on the level of granularity with the highest weight.

The aggregation engine 108 can perform an aggregation scheme based on the features of the forecast to be performed. For example, the aggregation scheme can include summing or averaging values that satisfy a condition for the forecast when features of the forecast are numerical. The aggregation scheme can also include a most frequent value or a concatenate of unique values that satisfy a condition for the forecast when features of the forecast are categorical. The aggregation scheme can be predetermined based on a type of feature, such as a numerical or categorical feature. The aggregation scheme can also be selected based on a particular feature, such as inventory, returns, replenishment, or price for a sales prediction target. The aggregation engine 108 can receive the selected aggregation scheme as aggregation data 110 and aggregate the level of granularity based on the aggregation data 110.

The forecast system 100 can further include a forecast engine 112 that can generate one or more forecast models that can output results of a forecast at the aggregated level of granularity output from the aggregation engine 108.

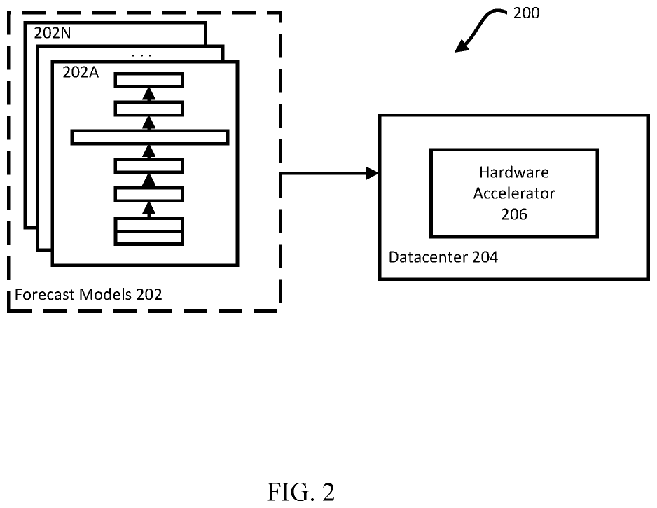

FIG. 2 depicts a block diagram 200 illustrating one or more forecast model architectures 202, more specifically 202A-N for each architecture, for deployment in a datacenter 204 housing a hardware accelerator 206 on which the deployed forecast models will execute for providing forecasting results at the target level of granularity. The hardware accelerator 206 can be any type of processor, such as a CPU, GPU, FPGA, or ASIC such as a TPU.

An architecture 202 of a forecast model can refer to characteristics defining the model, such as characteristics of layers for the model, how the layers process input, or how the layers interact with one another. For example, the forecast model can be a convolutional neural network (ConvNet) that includes a convolution layer that receives input time-series data, followed by a pooling layer, followed by a fully connected layer that generates a forecast result.

The architecture 202 of the forecast model can also define types of operations performed within each layer. For example, the architecture of a ConvNet may define that rectified linear unit (ReLU) activation functions are used in the fully connected layer of the network.

One or more forecast model architectures 202 can be generated that can output results of a forecast at the aggregated level of granularity.

Referring back to FIG. 1, the forecast engine 112 can also train the generated forecast models at various levels of granularity using the training data 104. The forecast engine 112 can perform training at multiple levels of a granularity hierarchy, where the output at any level of granularity is a combination of values at different levels of the granularity hierarchy. The forecast engine 112 can train forecast models at each level of granularity, at predetermined levels of granularity, a highest and lowest level of granularity, or a level of granularity that is dependent on another level of granularity. The forecast engine 112 can perform multiple iterations of training, where the combination of the iterations of training can be one of a weighted sum based on granularity level, a non-linear combination based on granularity level, or a linear or non-linear combination with constraints, such as normalization. The forecast engine 112 can apply regularization, such as ridge regression or lasso regression, during training at the multiple levels of the granularity hierarchy to mitigate for insufficient data leading to biased and/or overfit results.

The forecast system 100 can also include a distribution engine 114 for determining a distribution scheme and distributing the results 106 of the generated forecast models at the target level of granularity from the target evaluation metric data 102. The distribution engine 114 can compare accuracy of combinations of evaluation metrics at the target level of granularity using the training data 104, such as a validation dataset. Comparing the evaluation metrics can be represented as a hyperparameter tuning problem, where the number of hyperparameters can be the number of variables involved. The distribution engine 114 can include a hyperparameter tuning tool to solve the hyperparameter tuning problem. The hyper parameter tuning tool can include a black-box optimization. The distribution engine 114 can also solve the hyperparameter tuning problem with a grid search if the computational cost to exhaustively evaluate all possible combinations of evaluation metrics is small compared to training the model. For example, the distribution engine 114 can use a grid search if it increases the total runtime by less than a percentage threshold, such as 1%. The distribution engine 114 can also generate heuristics to narrow the number of combinations of evaluation metrics to compare. For example, it may already be known that some granularity differences are significant and cannot be ignored while other granularity differences are not significant and can be ignored. The forecast results 106 can be distributed at the target level of granularity based on the determined distribution scheme.

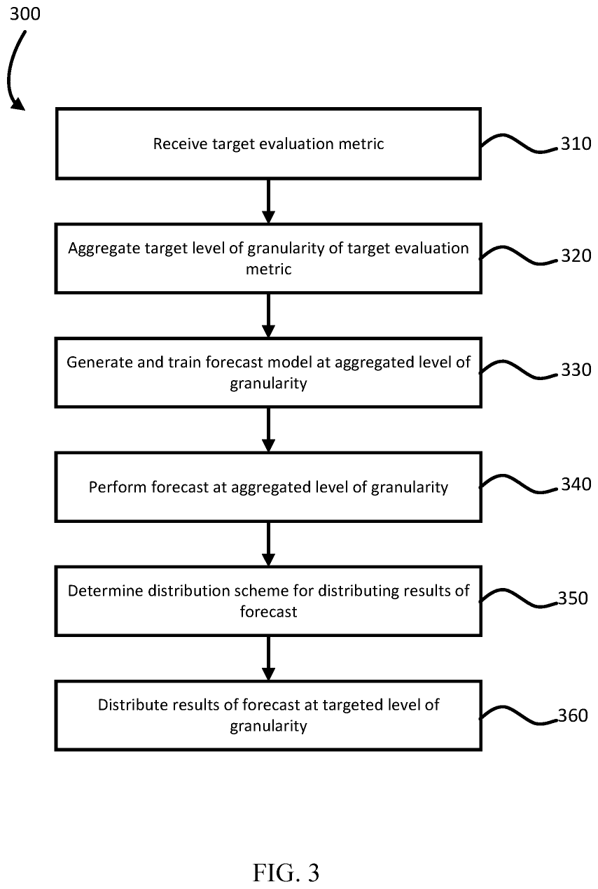

FIG. 3 depicts a flow diagram of an example process 300 for distributing forecast results at various levels of granularity. The example process 300 can be performed on a system of one or more processors in one or more locations, such as the forecast system 100 of FIG. 1.

As shown in block 310, the forecast system 100 can receive one or more target evaluation metrics. The target evaluation metrics can include a name of the metric and a target level of granularity of the metric. The evaluation metrics can measure quality, e.g., error, of the forecast models. Example evaluation metrics can include mean absolute error and root mean squared error. The granularity level of the metric can be the specificity of the evaluation for a feature. Example granularities can include levels of category, location, and time. Levels of category can include specificity of types of categorical features, levels of location can include a size of spatial features, and levels of time can include a length of temporal features.

One example use case may include forecasting retail sales of one or more stores. Categorical levels of granularity can include, from coarser to finer, sales of a type of product, sales of a sub-type of the type of products, and sales of a particular product. Location levels can include, from coarser to finer, sales from stores within a state, sales from stores within a city, or sales from a particular store. Time levels can include, from coarser to finer, monthly sales, weekly sales, and daily sales. Target levels of granularity tend to be finer, where meaningful data can be sparse, such as a sales of a particular product, sales at a particular store, or daily sales.

The forecast system 100 can also receive a weight for each evaluation metric if multiple evaluation metrics are received. If multiple received evaluation metrics are not at the same level of granularity, modeling can be performed at the granularity of the evaluation metric with the highest weight. Modeling can also be performed at the granularity of the evaluation metric with the highest accuracy based on testing performed with a validation dataset. A weight can also be received for granularity levels of a metric. The weight can determine which granularity levels have a more important accuracy for a particular forecast model.

As shown in block 320, the forecast system 100 can aggregate the target level of granularity of the evaluation metric. The aggregated level of granularity can be predetermined depending on the particular forecast model to be performed. For example, the aggregated level of granularity can be predetermined based on the level of granularity that would provide a threshold quality over a threshold period of time. As another example, the aggregated level of granularity can be predetermined based on the level of granularity with the highest weight.

Referring back to the forecasting retail sales example, a target level of granularity of daily sales of a product can be aggregated to monthly sales of that product if the forecast is mainly used for long-term planning, since monthly sales would provide sufficient quality results when performed by a forecast model.

Aggregating the target level of granularity can include summing or averaging values that satisfy a condition for the forecast when features of the forecast are numerical. Aggregating the level of granularity can also include a most frequent value or a concatenate of unique values that satisfy a condition for the forecast when features of the forecast are categorical. The aggregation scheme can be predetermined based on a type of feature, such as a numerical or categorical feature. The aggregation scheme can also be selected based on a particular feature, such as inventory, returns, replenishment, or price for a sales prediction target. Aggregating the target level of granularity can generate an aggregated dataset.

For the forecasting retail sales example, aggregating monthly sales of a product from the daily sales can include summing the daily sales of the product per month.

As shown in block 330, the forecast system 100 can generate and train a forecast model at the aggregated level of the granularity. The generated forecast model can be trained at the aggregated level of granularity using the aggregated dataset.

Training the forecast model at the aggregated level of granularity can include performing training at multiple levels of a granularity hierarchy, where the output at any level of granularity is a combination of values at different levels of the granularity hierarchy. For example, one forecast model can be trained at the highest level of granularity and another forecast model can be trained at the lowest level of granularity. As another example, a forecast model can be trained at each level of granularity, at predetermined levels of granularity, or at a level of granularity dependent on another level of granularity. Multiple iterations of training can be performed, where the combination of the iterations of training can be one of a weighted sum based on granularity level, a non-linear combination based on granularity level, or a linear or non-linear combination with constraints, such as normalization. Regularization, such as ridge regression or lasso regression, can be applied during training at the multiple levels of the granularity hierarchy to mitigate for insufficient data leading to biased and/or overfit results.

As shown in block 340, the generated forecast model can perform a forecast at the aggregated level of granularity. For the forecasting retail sales example, the forecast model would predict monthly sales of a product.

As shown in block 350, the forecast system 100 can determine a distribution scheme for distributing results of the generated forecast model at the target level of granularity. Determining the distribution scheme can include comparing accuracy of combinations of evaluation metrics at the target level of granularity using a validation dataset. Comparing the evaluation metrics can be represented as a hyperparameter tuning problem, where the number of hyperparameters can be the number of granularity layers between the aggregated level of granularity and the target level of granularity. For example, if the target level of granularity is individual items at day level, and the aggregated level of granularity is product type at monthly level, the intermediate levels can be product sub-types and weekly level.

The hyperparameter tuning problem can be solved by any hyperparameter tuning tool, such as black-box optimization, or can also be solved by a grid search. Instead of exhausting all combinations, the hyperparameter tuning tool can decide a most promising next hyperparameter trial to run based on results of previous hyperparameter trials. As an example, the hyperparameter tuning tool can stop after a predetermined amount of time and select the best result, such as a result with the highest score, from within that predetermined amount of time. As another example, the hyperparameter tuning tool can stop when results start approaching a convergence, where the hyperparameter tuning tool can select the result corresponding to the convergence. The selected result from the hyperparameter tuning tool can correspond to a determined distribution scheme. The hyperparameter tuning would not require retraining the forecast model and can be accomplished with minimal overhead, improving processing speeds for forecasting.

Determining the distribution scheme can also include generating heuristics to narrow the number of combinations of evaluation metrics to compare. For example, it may already be known that some granularity differences are significant and cannot be removed while other granularity differences are not significant and can be removed.

Referring back to the forecasting retail sales example, day-of-week difference for sales of a product can be significant while week-of-month difference can be insignificant. Similarly, hour-of-day difference for sales of a product can also be significant. Therefore, week-of-month combinations for the evaluation metric can be removed while day-of-week and/or hour-of-day combinations for the evaluation metric should remain.

As shown in block 360, the forecast system 100 can distribute the forecast results at the target level of granularity based on the determined distribution scheme.

FIG. 4 depicts a block diagram of an example environment 400 for implementing forecast model extensions to various levels of granularity. The system 400 can be implemented on one or more devices having one or more processors in one or more locations, such as in server computing device 402. Client computing device 404 and the server computing device 402 can be communicatively coupled to one or more storage devices 406 over a network 408. The storage devices 406 can be a combination of volatile and non-volatile memory and can be at the same or different physical locations than the computing devices 402, 404. For example, the storage devices 406 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of non-transitory computer readable medium capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that when executed by the processors 410, causes the one or more processors to perform actions defined by the instructions. The instructions 414 can be stored in object code format for direct processing by the processors 410, or in other formats including interpretable scripts or collections of independent source code modules that are interpreted on demand or compiled in advance. The instructions 414 can include instructions for implementing a forecast system 418, which can correspond to the forecast system 100 of FIG. 1. The forecast system 418 can be executed using the processors 410, and/or using other processors remotely located from the server computing device 402.

The data 416 can be retrieved, stored, or modified by the processors 410 in accordance with the instructions 414. The data 416 can be stored in computer registers, in a relational or non-relational database as a table having a plurality of different fields and records, or as JSON, YAML, proto, or XML documents. The data 416 can also be formatted in a computer-readable format such as, but not limited to, binary values, ASCII or Unicode. Moreover, the data 416 can include information sufficient to identify relevant information, such as numbers, descriptive text, proprietary codes, pointers, references to data stored in other memories, including other network locations, or information that is used by a function to calculate relevant data.

The client computing device 404 can also be configured similarly to the server computing device 402, with one or more processors 420, memory 422, instructions 424, and data 426. The client computing device 404 can also include a user input 428, and a user output 430. The user input 428 can include any appropriate mechanism or technique for receiving input from a user, such as keyboard, mouse, mechanical actuators, soft actuators, touchscreens, microphones, and sensors.

The server computing device 402 can be configured to transmit data to the client computing device 404, and the client computing device 404 can be configured to display at least a portion of the received data on a display implemented as part of the user output 430. The user output 430 can also be used for displaying an interface between the client computing device 404 and the server computing device 402. The user output 430 can alternatively or additionally include one or more speakers, transducers or other audio outputs, a haptic interface or other tactile feedback that provides non-visual and non-audible information to the platform user of the client computing device 404.

Although FIG. 4 illustrates the processors 410, 420 and the memories 412, 422 as being within the computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions and data can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404.

The server computing device 402 can be connected over the network 408 to a datacenter 432 housing hardware accelerators 432A-N. The datacenter 432 can be one of multiple datacenters or other facilities in which various types of computing devices, such as hardware accelerators, are located. The computing resources housed in the datacenter 432 can be specified for deploying forecast models, as described herein.

The server computing device 402 can be configured to receive requests to process data 426 from the client computing device 404 on computing resources in the datacenter 432. For example, the environment 400 can be part of a computing platform configured to provide a variety of services to users, through various user interfaces and/or APIs exposing the platform services. One or more services can be a machine learning framework or a set of tools for generating and/or utilizing forecasting neural networks or other machine learning forecasting models and distributing forecast results according to a target evaluation metric and/or training data. The client computing device 404 can receive and transmit data specifying the target evaluation metrics to be allocated for executing a forecasting model trained to perform demand forecasting. The forecast system 418 can receive the data specifying the target evaluation metric and/or the training data, and in response generate one or more forecasting models and distribute result of the forecast models based on the target evaluation metric, to be described further below.

As other examples of potential services provided by a platform implementing the environment 400, the server computing device 402 can maintain a variety of forecasting models in accordance with different potential target levels of granularity. For example, the server computing device 402 can maintain different families for deploying neural networks on the various types of TPUs and/or GPUs housed in the datacenter 432 or otherwise available for processing.

The devices 402, 404 and the datacenter 432 can be capable of direct and indirect communication over the network 408. For example, using a network socket, the client computing device 404 can connect to a service operating in the datacenter 432 through an Internet protocol. The devices 402, 404 can set up listening sockets that may accept an initiating connection for sending and receiving information. The network 408 itself can include various configurations and protocols including the Internet, World Wide Web, intranets, virtual private networks, wide area networks, local networks, and private networks using communication protocols proprietary to one or more companies. The network 408 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 408, in addition or alternatively, can also support wired connections between the devices 402, 404 and the datacenter 432, including over various types of Ethernet connection.

Although a single server computing device 402, client computing device 404, and datacenter 432 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing neural networks, and any combination thereof.

As such, generally disclosed herein are implementations for extending forecasting models to various levels of granularity, such as finer levels of granularity where accuracy is difficult to achieve. The implementations include receiving a target evaluation metric for distributing a forecast, performing forecast modeling at an aggregated level of granularity compared to the target level of granularity, and determining a distribution scheme to distribute results of the forecast model at the target level of granularity. The approach can improve performance over existing forecasting models with minimal overhead.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for forecasting independent of level of granularity, the method comprising:
receiving, with one or more processors, a target evaluation metric for performing a forecast, the target evaluation metric comprising a target level of granularity;
performing, with the one or more processors, the forecast at an aggregated level of granularity compared to the target level of granularity to generate an aggregated forecast result;
determining, with the one or more processors, a distribution scheme for distributing the aggregated forecast result to the target level of granularity; and
distributing, with the one or more processors, the aggregated forecast result to the target level of granularity based on the determined distribution method to generate a forecast result at the target level of granularity.

2. The method of claim 1, wherein data for the forecasting at the target level of granularity is sparse.

3. The method of claim 1, wherein the target evaluation metric comprises a target quality for the forecasting model.

4. The method of claim 1, wherein the target level of granularity comprises a level of a category, location, or time.

5. The method of claim 1, wherein the target evaluation metric further comprises a weight, the target level of granularity being based on the weight.

6. The method of claim 1, further comprising aggregating, with the one or more processors, the target level of granularity via an aggregation scheme.

7. The method of claim 6, wherein the aggregation scheme comprises one of a sum or average for numerical features of data for the forecasting.

8. The method of claim 6, wherein the aggregation scheme comprises one of a most frequent value or a concatenate of unique values for categorical features of data for the forecast.

9. The method of claim 1, further comprising performing, with the one or more processors, training for the forecast at the aggregated level of granularity.

10. The method of claim 1, wherein determining the distribution method further comprises comparing an accuracy of combinations of evaluation metrics at the target level of granularity using a validation dataset.

11. The method of claim 10, wherein determining the distribution method further comprises generating heuristics to narrow the combination of evaluation metrics to compare.

12. A system comprising:
one or more processors; and
one or more storage devices coupled to the one or more processors and storing instructions that, when executed by the one or more processors, causes the one or more processors to perform operations for forecasting independent of level of granularity, the operations comprising:
receiving a target evaluation metric for performing a forecast, the target evaluation metric comprising a target level of granularity;
performing the forecast at an aggregated level of granularity compared to the target level of granularity to generate an aggregated forecast result;
determining a distribution scheme for distributing the aggregated forecast result to the target level of granularity; and
distributing the aggregated forecast result to the target level of granularity based on the determined distribution method to generate a forecast result at the target level of granularity.

13. The system of claim 12, wherein the target level of granularity comprises a level of a category, location, or time.

14. The system of claim 12, wherein the operations further comprise aggregating the target level of granularity via an aggregation scheme, the aggregation scheme comprising one of a sum or average for numerical features of data for the forecasting or a most frequent value or a concatenate of unique values for categorical features of data for the forecast.

15. The system of claim 12, wherein determining the distribution method further comprises comparing an accuracy of combinations of evaluation metrics at the target level of granularity using a validation dataset.

16. The system of claim 15, wherein determining the distribution method further comprises generating heuristics to narrow the combination of evaluation metrics to compare.

17. A non-transitory computer readable medium for storing instructions that, when executed by one or more processors, causes the one or more processors to perform operations for forecasting independent of level of granularity, the operations comprising:
receiving a target evaluation metric for performing a forecast, the target evaluation metric comprising a target level of granularity;
performing the forecast at an aggregated level of granularity compared to the target level of granularity to generate an aggregated forecast result;
determining a distribution scheme for distributing the aggregated forecast result to the target level of granularity; and
distributing the aggregated forecast result to the target level of granularity based on the determined distribution method to generate a forecast result at the target level of granularity.

18. The non-transitory computer readable medium of claim 17, wherein the operations further comprise aggregating the target level of granularity via an aggregation scheme, the aggregation scheme comprising one of a sum or average for numerical features of data for the forecasting or a most frequent value or a concatenate of unique values for categorical features of data for the forecast.

19. The non-transitory computer readable medium of claim 17, wherein determining the distribution method further comprises comparing an accuracy of combinations of evaluation metrics at the target level of granularity using a validation dataset.

20. The non-transitory computer readable medium of claim 19, wherein determining the distribution method further comprises generating heuristics to narrow the combination of evaluation metrics to compare.
